(19) United States
(12) Patent Application Publication
(10) Pub. No.: US 2005/0122606 A1
(43) Pub. Date: Jun. 9, 2005

(54) Position measuring apparatus and positioning apparatus for magnetic transfer master carriers

(75) Inventor: Akito Kamatani, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/002,132

(22) Filed: Dec. 3, 2004

(30) Foreign Application Priority Data
Dec. 4, 2003 (JP) 406040/2003

(51) Int. Cl. G11B 5/86

(52) U.S. Cl. 360/17

(57) ABSTRACT

A position measuring apparatus and a positioning apparatus are provided that enable easy and accurate positioning of master carriers with respect to transfer holders. A rotating mechanism for rotating a transfer holder, in which a master carrier is held, and a detector for detecting detection marks, which are provided on the master carrier in an arcuate manner, are provided. The detection marks are detected while the transfer holder is rotated, to measure the amount of displacement of the center position of the master carrier with respect to the rotational center of the transfer holder. Further, a pressing mechanism for imparting force onto the master carrier in the radial direction is thereof is provided. The master carrier is positioned by performing positional correction, based on the amount and direction of displacement of the center position of the master carrier.

### BACKGROUND OF THE INVENTION

1. Field of the Invention

The present invention relates to a position measuring apparatus and a positioning apparatus for magnetic transfer master carriers, which are utilized during positioning and holding of a master carrier within a magnetic transfer apparatus that performs magnetic transfer by placing the master carrier, which bears information thereon, held in a transfer holder, into close contact with a slave medium.

2. Description of the Related Art

Magnetic transfer, to which the present invention is related, is a method of recording magnetic patterns that correspond to information on a slave medium. A master carrier (patterned master) bearing a transfer pattern, such as servo signals, formed as a pattern of protrusions and depressions or a pattern of embedded magnetic material, is placed in close contact with a slave medium having a magnetic recording portion. In this state of close contact, a transfer magnetic field is applied to magnetically transfer and record the magnetic pattern onto the slave medium.

In the case that the slave medium is a discoid medium, such as a hard disk or a high density flexible disk, discoid master carriers are placed in close contact with both sides thereof. In this state of close contact, a magnetic field applying apparatus comprising electromagnets or permanent magnets is provided on either one side or both sides of the slave medium, to apply the transfer magnetic field.

An important requirement for magnetic transfer is the accurate positioning of the master carrier and the slave medium. Particularly for slave media such as hard disks and high density flexible disks, it is necessary that the rotational centers thereof and the centers of the magnetic patterns transferred and recorded thereon are accurately matched.

In view of the above point, there is known an imaging apparatus that positions master carriers and slave media. Specifically, first, a slave medium is set on a close contact flange. Next, a master carrier, having a marker corresponding to a magnetic pattern thereon at a transparent portion thereof, is placed on the slave medium. The imaging apparatus adjusts the position of the master carrier while observing the position of the marker and the slave medium so that their positions match. Then, the master carrier and the slave medium are placed in close contact with each other (refer to Japanese Unexamined Patent Publication No. 11(1999)-175973). There is also a known apparatus that holds a master carrier in a holder, which is movable in the X-Y directions. A CCD camera observes the center position of the master carrier, and the center position is matched with the center position of a slave medium, prior to placing them in close contact with each other (refer to Japanese Unexamined Patent Publication No. 2001-209978).

In the case that signals are magnetically transferred onto slave media, the radial centers of the slave media, that is, the center positions of the transferred signal patterns, the required degree of concentricity is on the order of several tens of microns. In order to realize this degree of positioning accuracy, it had been necessary for the center of a transfer pattern on a master carrier, the radial center of a slave medium, and the rotational center of a transfer holder to be accurately matched.

Various means exist to realize the above positioning. Such means include positioning pins, which are provided on a transfer holder, to position and hold master carriers. Others, like the apparatuses disclosed in the aforementioned Patent Publications, detect the center positions of patterns by employing comparators and the like, and adjust the position of the master carrier, held within transfer holders, by means that press the outer periphery thereof in four directions. However, these methods and apparatuses have problems in that sufficiently accurate positioning is not obtained, and that operations are troublesome and require experience.

### SUMMARY OF THE INVENTION

The present invention has been developed in view of the above points. It is an object of the present invention to provide a position measuring apparatus and a positioning apparatus that enable accurate positional adjustment of a master carrier with respect to a transfer holder.

The position measuring apparatus for magnetic transfer master carriers of the present invention comprises:
a transfer holder, on which a magnetic transfer master carriers is held;
a rotating mechanism for rotating the transfer holder; and
a detector for detecting detection marks, which are provided on the master carrier in an arcuate manner; wherein
the detection marks are detected while the transfer holder is rotated; and
the amount of displacement of the center of the master carrier with respect to the rotational center of the transfer holder is measured.

The positioning apparatus for magnetic transfer master carriers of the present invention comprises:
a transfer holder, on which a magnetic transfer master carrier is held;
a rotating mechanism for rotating the transfer holder;
a detector for detecting detection marks, which are provided on the master carrier in an arcuate manner; and
a pressing mechanism for applying force in the radial direction of the master carrier; wherein
the detection marks are detected while the transfer holder is rotated;
the amount of displacement of the center of the master carrier with respect to the rotational center of the transfer holder is measured; and
the pressing mechanism presses the master carrier in the radial direction thereof, according to the measured amount and direction of displacement, to correct the position of the master carrier with respect to the transfer holder.

The position measuring apparatus of the present invention as described above comprises the transfer holder, on which the magnetic transfer master carriers is held; the rotating mechanism for rotating the transfer holder; and the detector for detecting the detection marks, which are provided on the master carrier in an arcuate manner. By detecting the detection marks while the transfer holder is rotated, to measure the amount of displacement of the center of the master carrier with respect to the rotational center of the transfer holder, the center position of the transfer pattern of the master carrier can be easily and accurately measured.

The positioning apparatus of the present invention comprises the transfer holder, on which the magnetic transfer master carrier is held; the rotating mechanism for rotating the transfer holder; the detector for detecting the detection marks, which are provided on the master carrier in an arcuate manner; and the pressing mechanism for applying force in the radial direction of the master carrier. By detecting the detection marks while the transfer holder is rotated, the amount of displacement of the center of the master carrier with respect to the rotational center of the transfer holder can be measured. By pressing the master carrier in the radial direction thereof in an amount and direction corresponding to the measured displacement to correct and position the master carrier, highly accurate positioning is enabled with a simple structure. This facilitates automation, and improves operating efficiency.

### BRIEF DESCRIPTION OF THE DRAWINGS

FIG. 1 is a perspective view that illustrates a transfer holder, of a magnetic transfer apparatus, in an open state.

FIGS. 2A and 2B illustrate a positioning apparatus that positions a master carrier within the holder, wherein FIG. 2A is a schematic front view, and FIG. 2B is a schematic plan view.

FIG. 3 is a flow chart that illustrates the procedures for positioning the master carrier within the holder.

FIGS. 4A, 4B, 4C, and 4D are schematic plan views illustrating examples of distal ends of a pressing member of a pressing mechanism.

FIGS. 5A, 5B, and 5C are plan views that illustrates examples of detection marks provided on the master carrier.

### DESCRIPTION OF THE PREFERRED EMBODIMENTS

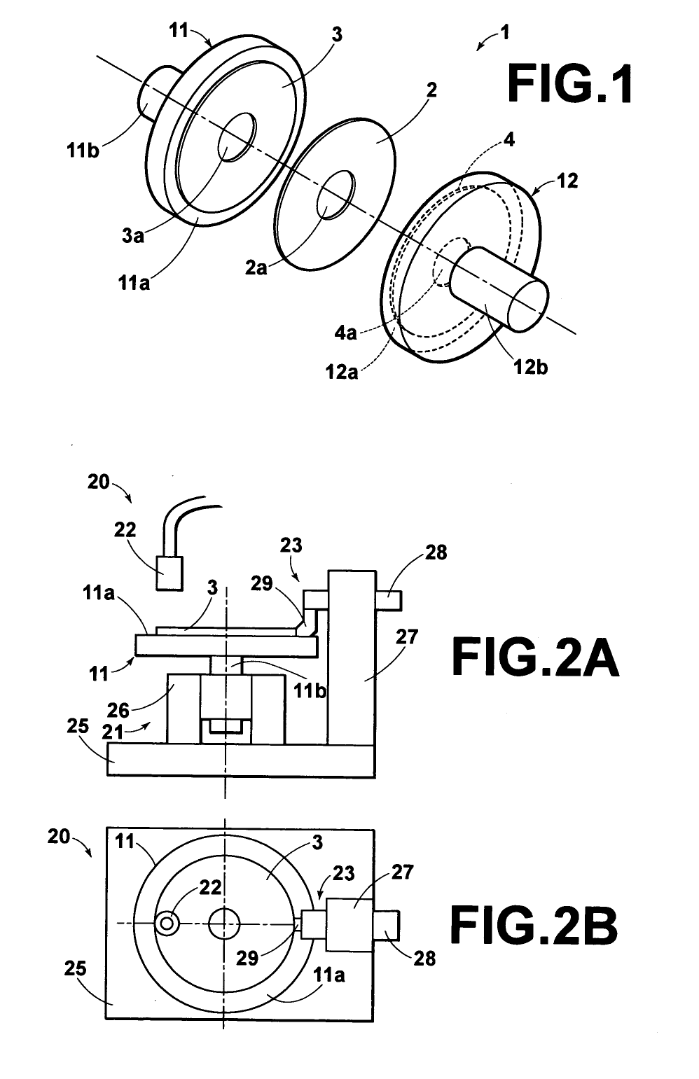

Hereinafter, the present invention will be described in detail, with reference to the embodiments illustrated in the attached drawings. FIG. 1 is a schematic perspective view illustrating a transfer holder 1 of a magnetic transfer apparatus in its open state. Note that the figures are model drawings, and that dimensions of the constituent parts are shown at ratios different from the actual ratios thereof.

The transfer holder 1 of the magnetic transfer apparatus illustrated in FIG. 1 comprises a first holder 11 and a second holder 12, which are movable so as to contact and separate from each other. A first master carrier 3 is held within the first holder 11, and a second master carrier 4 is held within the second holder 12. The mater carriers 3 and 4 are placed in close contact with both sides of a slave medium 2 held therebetween, by the holders 11 and 12 approaching each other.

Note that although not shown in the figure, the magnetic transfer apparatus further comprises a vacuum suction means and a magnetic field applying means. The vacuum suction means depressurizes a sealed interior space formed by the first and second holders 11 and 12 of the transfer holder 1, to obtain close contact of the master carriers and the slave medium held therein. The magnetic field applying means applies magnetic fields to the transfer holder 1 while it is being rotated. Note also that “close contact” among the slave medium 2 and the master carriers 3 and 4 refer to a case in which slight gaps exist among them, in addition to actual contact.

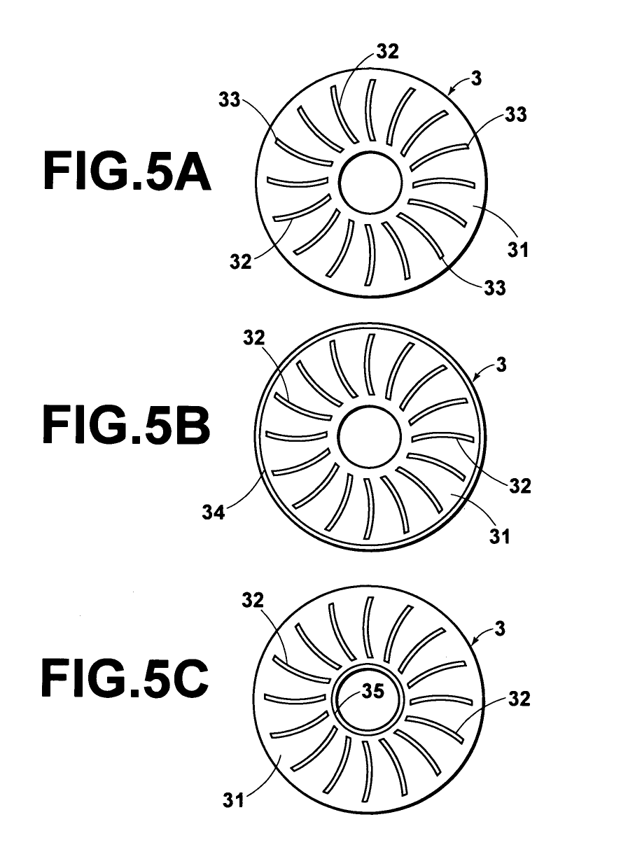

The slave medium 2 is discoid in shape, and has a central aperture 2a of a predetermined radius. The slave medium 2 is a discoid magnetic recording medium, such as a high density flexible disk or a hard disk, on which magnetic recording portions (magnetic layers) have been formed on both sides thereof. The magnetic recording portions may be formed by coated magnetic recording layers, or by metallic thin film magnetic recording layers. The master carriers 3 and 4 are formed to be discoid in shape, and have central apertures 3a and 4a having radii substantially equal to that of the central aperture 2a of the slave medium 2. The master carriers 3 and 4 differ in that the pattern 32 (refer to FIG. 5) to be transferred to a first side of the slave medium 2 and the pattern 32 to be transferred to a second side of the slave medium 2 are reversed. However, they are formed to be the same in other respects.

FIGS. 5A, 5B, and 5C illustrate the master carrier 3 for the first side of the slave medium 2. The magnetic pattern 32, which comprises a fine pattern of protrusions and depressions on a substrate coated with soft magnetic material, is formed on concentric tracks so that they extend substantially in the radial direction. Detection marks 33˜35 are provided in an arcuate manner, at a plurality of points concentric with the tracks, in order to detect the center position of the transfer pattern 32.

In the master carrier 3 illustrated in FIG. 5A, detection marks 33 are provided at at least three locations at the outer peripheral edge of the transfer pattern 32. The detection marks 33 are employed to determine the center position of the master carrier 3. Alternatively, detection marks may be provided at locations at the inner peripheral edge of the transfer pattern 32. By employing portions of the transfer pattern 32, formed by the pattern of protrusions and depressions, as the detection marks for measuring the center position of the master carrier 3, accurate positional detection becomes possible.

In the master carrier 3 illustrated in FIG. 5B, detection marks 34 are provided at the exterior of the region in which the transfer pattern 32 is formed. The center position of the master carrier 3 is determined by detecting the detection marks 34. In the master carrier 3 illustrated in FIG. 5C, arcuate detection marks 35 are provided at the interior of the region in which the transfer pattern 32 is formed. The center position of the master carrier 3 is determined by detecting the detection marks 35.

In the case that arcuate detection marks 34 or 35, as described above, are employed, positional detection is facilitated, thereby enabling low cost, high speed positional detection. In addition, the arcuate detection marks 34 and 35 are preferable, because they are provided at the exterior and the interior of the transfer pattern 32, respectively, thereby precluding any influence from being exerted onto the transfer pattern 32. Further, if the forming of the detection marks 34 or 35 on the master carrier 3 is performed simultaneously with the forming of the transfer pattern 32 employing the same means, the manufacturing process of the master carrier 3 may be simplified.

As illustrated in FIG. 1, the first holder 11 and the second holder 12 are discoid in shape, and have circular inner surfaces 11a and 12a, respectively. The circular inner surfaces 11a and 12a have diameters greater than the outer diameters of the master carriers 3 and 4. The master carriers 3 and 4 are set on the inner surfaces 11a and 12a, respectively. A positioning apparatus 20 (refer to FIG. 2), which also serves as a position measuring apparatus, measures and adjusts the center positions of the transfer patterns 32 formed on the master carriers 3 and 4 so that they match the centers of the holders 11 and 12 to a predetermined level of positional accuracy. Support shafts 11b and 12b, for supporting the holders 11 and 12 in a rotatable manner, are provided on the rear surfaces of the holders 11 and 12, respectively. Note that great numbers of air suction apertures (not shown) are substantially uniformly provided through the inner surfaces 11a and 12a of the holders, to hold the master carriers 3 and 4 by vacuum suction. Elastic material may be provided between the inner surfaces 11a and 12a and the master carriers 3 and 4, to improve the close contact properties among the slave medium 2 and the master carriers 3 and 4.

One or both of the first holder 11 and the second holder 12 are provided to be movable in the axial direction to open and close the transfer holder 1. The first holder 11 and the second holder 12 are linked to a rotating mechanism (not shown) so that they are rotatable as an integral unit. The rotating mechanism also enables rotation of the holders 11 and 12 relative to one another. The relative rotation enables adjustment of the positional phase.

FIGS. 2A and 2B illustrate the positioning apparatus 20 that sets the master carrier 3 on the inner surface 11a of the holder 11, wherein FIG. 2A is a schematic front view, and FIG. 2B is a schematic plan view. The positioning apparatus 20 comprises: a rotating mechanism 21; a detector 22; and a pressing mechanism 23. The rotating mechanism 21 rotates the first holder 11 with the master carrier 3 held therein. The detector 22 detects the detection marks 33˜35, which are provided on the master carrier 3 in an arcuate manner. The pressing mechanism 23 imparts force to the master carrier 3 in the radial direction thereof.

The positioning apparatus 20 detects the detection marks 33˜35 on the master carrier 3 with the detector 22 while the holder 11 is rotated, to measure the amount of displacement of the center of the master carrier 3 with respect to the rotational center of the holder 11. Then, the pressing mechanism 23 presses the master carrier 3 in the radial direction thereof, according to the measured amount and direction of displacement, to correct the position of the master carrier 3 with respect to the holder 11. Thereby, the center positions of the master carrier 3 and the holder 11 are simply and accurately matched.

Note that the positioning apparatus 20 also serves as a position measuring apparatus, comprising the rotating means 21 and the detector 22. The positioning apparatus 20 detects the detection marks 33˜35 on the master carrier 3 while the holder 11 is rotated, to measure the amount of displacement of the center of the master carrier 3 with respect to the rotational center of the holder 11.

The positioning apparatus 20 will be described in detail. The rotating mechanism 21 comprises a base 25 and a rotational support stage 26 provided on the base 25. The support shaft 11b is held in the vertical orientation by the rotational support stage 26, such that the inner surface 11a faces upward. The master carrier 3 is placed on the inner surface 11a. The rotation of the holder 11 by the rotating mechanism 21 may be performed either manually or automatically. The rotating mechanism 21 is linked to a drive mechanism (not shown).

The detector 22 is provided above the master carrier 3, and comprises an image sensor, such as a CCD camera, for detecting the detection marks 33˜35. The detector 22 is linked to an image processing/calculating means (not shown) for processing an image obtained by the detector 22 to calculate the center position of the master carrier 3 based on the coordinate positions of the detection marks 33˜35.

If an image sensor is employed as the detector 22 for detecting the detection marks 33˜35, highly accurate positional detection is enabled, as well as automation of the positional detection and positioning operations. If a comparator (measuring microscope) is employed as the detector, highly accurate positional detection is enabled, and costs can be reduced compared to a case in which a dedicated image sensor is employed.

Further, the pressing mechanism 23 comprises a support column 27, which is erected on the base 25, and an actuator 28, which is provided on the support column 27. A pressing member 29, provided at the distal end of the actuator 29, abuts the outer periphery of the master carrier 3 to correct the position thereof by pressing it in the radial direction thereof. The position of the master carrier 3 is corrected so that the center of the transfer pattern 32 thereon and the rotational center of the holder 11 are accurately matched. The shape of the distal end of the pressing member 29 that contacts the master carrier 3 will be described later, with reference to FIG. 4.

The amount of displacement of the center of the master carrier 3 with respect to the rotational center of the holder 11 is measured while the holder 11 is rotated. Next, the rotation is stopped so that the displacement direction of the master carrier 3 and the pressing direction of the pressing mechanism 23 are matched. Then, the pressing mechanism 23 presses the master carrier 3 to perform positional correction.

At this time, the relative phase of the detector 22 with respect to the pressing mechanism 23 may be arbitrary. After detection by the detector 22, the phase of the master carrier 3, to be pressed, may be matched with the phase of the pressing mechanism 23.

In the case that the master carrier 3 is held on the inner surface 11a of the holder 11 by means of vacuum suction, it is preferable that the degree of vacuum is reduced during operation of the pressing mechanism 23, to facilitate movement of the master carrier 3. In this case, the preferred degree of vacuum is −1kPa˜−20 kPa.

By repeating the detection of the center position of the master carrier 3 and the center position correction by the pressing operation several times, the center position of the master carrier 3 converges to within a predetermined range, enabling even higher accuracy positioning.

The pressing mechanism 23 may perform positional correction of the master carrier 3 automatically, by employing the actuator 28. Alternatively, the positional correction may be performed manually, employing micrometers and the like. During positional correction, it is desirable that a side surface of the inner or outer periphery of the master carrier 3 is pressed, and that contact with the surface thereof is avoided. This is because contact with the surface of the master carrier 3 may lead to problems such as contamination and damage thereof.

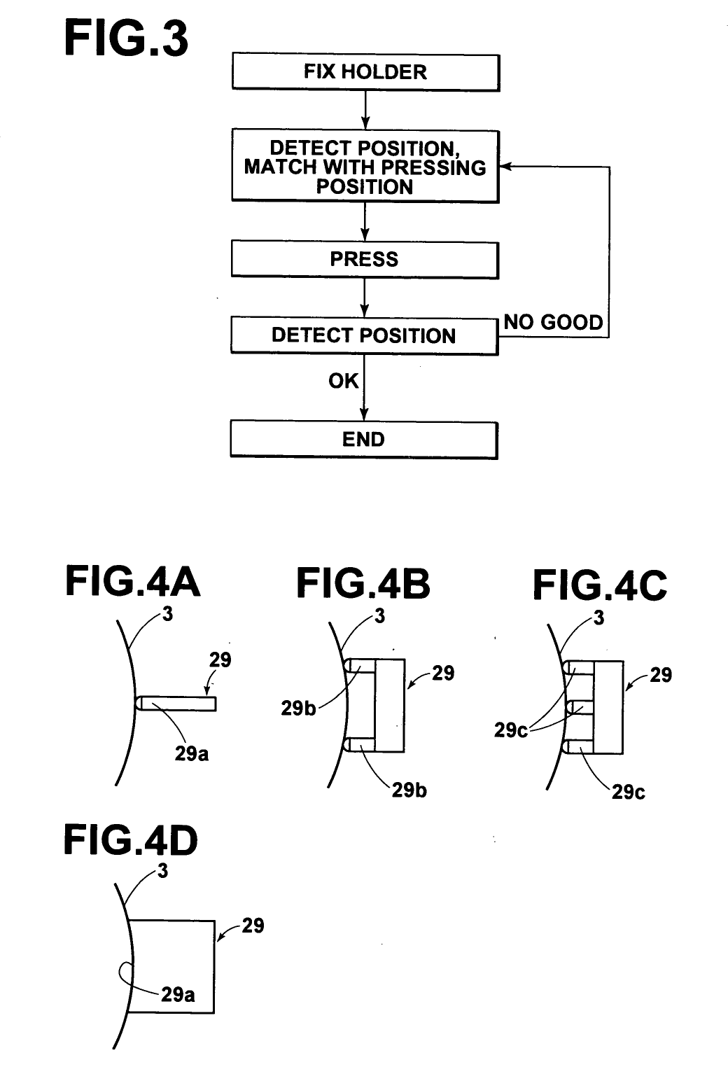

The positioning of the master carrier 3 by the positioning apparatus 20 is performed according to the procedure illustrated in the flow chart of FIG. 3.

First, the holder 11 is fixed in a reference state. Next, the detector 22 reads out the positions of the detection marks 33˜35 on the master carrier 3 while the holder 11 is rotated. The center position of the transfer pattern 32 of the master carrier 3 is calculated, and the amount and the direction (phase angle) of displacement are determined. Then, rotation of the holder 11 is stopped at a position where the angular position of the direction of displacement of the master carrier 3 matches the pressing direction of the pressing member 29 of the pressing mechanism 23. Next, the pressing mechanism 23 is operated to perform positional correction, by pressing the master carrier 3 for a distance corresponding to the amount of displacement. Thereafter, the amount of displacement of the center position of the master carrier 3 is detected by the detector 22, and the process is repeated until the master carrier 3 is in a predetermined positioning state. The positioning operation is completed after it is confirmed that the center of the holder 11 and the center of the master carrier 3 are within an allowable range with respect to each other.

The detection and pressing operations are not limited to being performed within the magnetic transfer apparatus. Alternatively, the center positions of the transfer patterns 32 of the master carriers 3 and 4 may be optimized in an off line set up procedure.

The shape of the distal end of the pressing member 29 of the pressing mechanism 23 is interchangeable according to the intended use, as illustrated in FIGS. 4A, 4B, 4C, and 4D.

FIG. 4A illustrates a case in which the distal end of the pressing member 29 is constituted by a single rod 29a. In this case, the outer (or inner) periphery of the master carrier 3 is supported at one point. This minimizes the contact area, and enables suppression of contaminant adherence and damage to the master carrier 3.

FIG. 4B illustrates a case in which the distal end of the pressing member 29 is constituted by two rods 29b, and FIG. 4C illustrates a case in which the distal end of the pressing member 29 is constituted by three rods 29c. In these cases, the master carrier 3 can be moved stably when the outer (or inner) periphery of the master carrier 3 is pressed in the pressing direction, supported by two or three points. The contact area is small, which enables suppression of contaminant adherence and damage to the master carrier 3.

FIG. 4D illustrates a case in which the distal end of the pressing member 29 is constituted by a pressing surface 29d, which has a curvature that matches the curvature of the outer periphery of the master carrier 3. By forming the pressing portion to match the curvature of the outer (or inner) periphery of the master carrier 3, the master carrier 3 can be moved stably in the pressing direction.

Note that the portion of the pressing member 29 that contacts the master carrier may alternatively be constituted by elastic material. In this case, damage to the master carrier 3 can be prevented.

In addition, the pressing mechanism 23 may further comprise a pressure detector (not shown), and be set such that pressing operations are performed at a prescribed pressure or less. In this case, if excessive pressure is applied, operation of the pressing mechanism 23 can be stopped to prevent damage to the master carrier 3.

According to the embodiment described above, each of the master carriers 3 and 4 are positioned within the holders 11 and 12 of the transfer holder 1, respectively. The positioning is performed by the position measuring apparatus, comprising the rotating mechanism 21 and the detector 22, and by the positioning apparatus 20, comprising the pressing mechanism 23. First, the position measuring apparatus accurately measures the amounts of displacement of the center positions of the master carriers 3 and 4 with respect to the holders 11 and 12, respectively, by the detector 22 detecting the detection marks 33˜35, which are provided on the master carriers 3 and 4 in an arcuate manner. The positioning apparatus 20 presses the master carriers 3 and 4 based on the measured amounts and directions of displacement, to easily and accurately position the master carriers 3 and 4 at the center positions of the holders 11 and 12, respectively.

1. A position measuring apparatus for magnetic transfer master carriers, comprising:
a transfer holder, on which a magnetic transfer master carriers is held;
a rotating mechanism for rotating the transfer holder; and
a detector for detecting detection marks, which are provided on the master carrier in an arcuate manner; wherein
the detection marks are detected while the transfer holder is rotated; and
the amount of displacement of the center of the master carrier with respect to the rotational center of the transfer holder is measured.

2. A positioning apparatus for magnetic transfer master carriers, comprising:
a transfer holder, on which a magnetic transfer master carrier is held;
a rotating mechanism for rotating the transfer holder;
a detector for detecting detection marks, which are provided on the master carrier in an arcuate manner; and
a pressing mechanism for applying force in the radial direction of the master carrier; wherein
the detection marks are detected while the transfer holder is rotated;
the amount of displacement of the center of the master carrier with respect to the rotational center of the transfer holder is measured; and
the pressing mechanism presses the master carrier in the radial direction thereof, according to the measured amount and direction of displacement, to correct the position of the master carrier with respect to the transfer holder.

3. A position measuring apparatus for magnetic transfer master carriers as defined in claim 1, wherein:
the detector is a measuring microscope.

4. A positioning apparatus for magnetic transfer master carriers as defined in claim 2, wherein:
the detector is a measuring microscope.

5. A position measuring apparatus for magnetic transfer master carriers as defined in claim 1, wherein:
the transfer holder holds the master carrier by means of vacuum suction.

6. A positioning apparatus for magnetic transfer master carriers as defined in claim 2, wherein:
the transfer holder holds the master carrier by means of vacuum suction.
